(19) United States
(12) Patent Application Publication
(10) Pub. No.: US 2005/0232127 A1
(43) Pub. Date: Oct. 20, 2005

(54) Information carrier drive device provided with a double antenna

(76) Inventor: Josephus Kahlman, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/520,189

(22) PCT Filed: Jun. 27, 2003
(86) PCT No.: PCT/IB03/02728

§ 371 Date: Jan. 4, 2005

(30) Foreign Application Priority Data
Jul. 8, 2002 (EP) 02077715.7

(51) Int. Cl. G11B 7/26; G11B 5/09

(52) U.S. Cl. 369/273; 369/52.1

(57) ABSTRACT

An apparatus is provided for reading an information carrier (1) which has an integrated circuit (21) and an antenna (22) coupled to the integrated circuit. The apparatus has communication means to establish communication between the integrated circuit on the disc and the apparatus. The communication means has two antennas (66,67): one which can communicate with the integrated circuit on the disc when the disc is loaded in the apparatus and one which provides communication between the apparatus and the integrated circuit on the information carrier when the disc is in the vicinity of the apparatus.

The invention relates to an apparatus for reading out an information carrier, which information carrier is provided with an integrated circuit and an antenna connected to the integrated circuit, said apparatus being provided with communication means for achieving an electromagnetic coupling with the antenna on the information carrier.

An apparatus as described in the opening paragraph is known from U.S. Pat. No. 6,044,046. In this system, an integrated circuit (denoted chip hereinafter) is provided on an information carrier for the purpose of storing additional information. The information carrier may be, for example, a disc with an optical storage unit, such as a CD or DVD. These discs may be used for storing and filing comparatively large quantities of data in a simple manner, for example digital photos, films, and music albums. This information, which is protected by copyright, i.e. the digital work, can be stored in an encoded manner on the information carrier so as to counteract illegal distribution. The additional information stored in the chip is, for example, a decoding key with which the encoded digital work on the information carrier can be decoded.

The information carrier is to be loaded into the playback apparatus if the digital work stored on the information carrier is to be reproduced. The playback apparatus comprises optical reading means which render possible the read-out of the optical storage unit.

The chip is provided with electromagnetic receiver means for obtaining the energy necessary for the operation of the chip. Electromagnetic transmitter and receiver means are furthermore present on the chip of the information carrier so as to render possible a communication between the chip and the playback apparatus.

Communication means rendering possible this communication are present in the playback apparatus. The communication means in the apparatus are formed, for example, by an integrated circuit, a so-termed read-out IC, and an antenna. The communication means in the existing system are designed such that communication can take place between the chip on the information carrier and the read-out IC in-the apparatus only if the information carrier is present inside the apparatus.

It is a disadvantage of the known apparatus that the communication between the chip and the read-out IC can only take place when the information carrier is present in the playback apparatus.

It is an object of the invention to provide an apparatus of the kind mentioned in the opening paragraph which renders possible a communication between the chip and the read-out IC which is not limited to a fixed position of the information carrier in the playback apparatus.

This object is achieved in that the communication means are constructed such that the communication between the integrated circuit and the apparatus can take place both when the information carrier is present inside the apparatus and when the information carrier is present in the vicinity of the apparatus.

The invention is based on the recognition that it is favorable in some cases to render possible a communication with the chip on the information carrier also in the vicinity of the playback apparatus. The information stored in the chip may be, for example, the table of contents of the information carrier. If the stored digital work comprises, for example, music albums, such an information carrier will quite probably comprise dozens of titles. It would be very convenient for the user of the system if he/she could read the table of contents by just holding the information carrier close to the playback apparatus. The communication means in the playback apparatus may then display this information, for example, on a screen. The user can obtain the desired data easily and quickly in this manner.

In an embodiment of the apparatus according to the invention, the communication means of the apparatus comprise at least two antennas. One of these antennas is present, for example, on the pressure body of the playback apparatus. This position renders it possible for the chip on the information carrier to be read when the information carrier is inside the apparatus. A further antenna will then be located, for example, on or adjacent an outer wall of the apparatus. The location of this antenna renders it possible to communicate with the chip also outside the apparatus.

An embodiment of the apparatus according to the invention is characterized in that at least two antennas are coupled to one read-out IC.

The advantage of this measure is that the cost of the communication means present in the apparatus can be reduced.

In the prior-art system, the communication means in the playback apparatus comprise one read-out IC connected to one antenna. These means are capable of achieving an electromagnetic coupling with an antenna on the information carrier. If a second antenna is desired in the apparatus, for example for reading the table of contents without having to load the information into the apparatus, it would seem logical to use an additional read-out IC connected to an additional antenna. The embodiment is based on the recognition that the cost of the communication means can be reduced in that one read-out IC is used, to which two antennas are coupled.

These and further aspects of the apparatus according to the invention will be explained in more detail below with reference to drawings, in which:

FIG. 1 is a diagrammatic plan view of an embodiment of the information carrier,

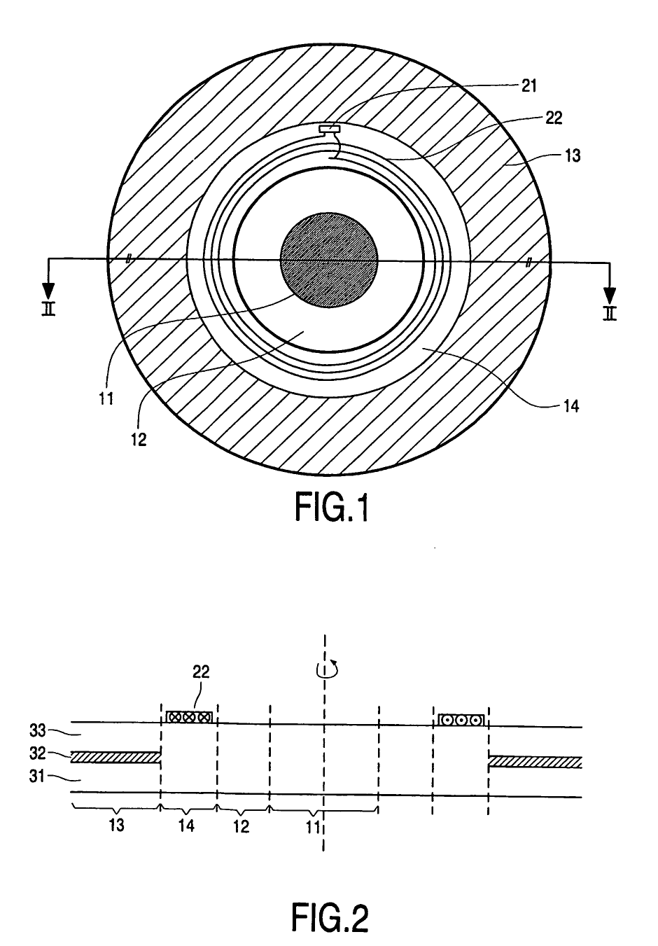

FIG. 2 is a diagrammatic cross-sectional view of the embodiment of the information carrier taken on the line II-II in FIG. 1,

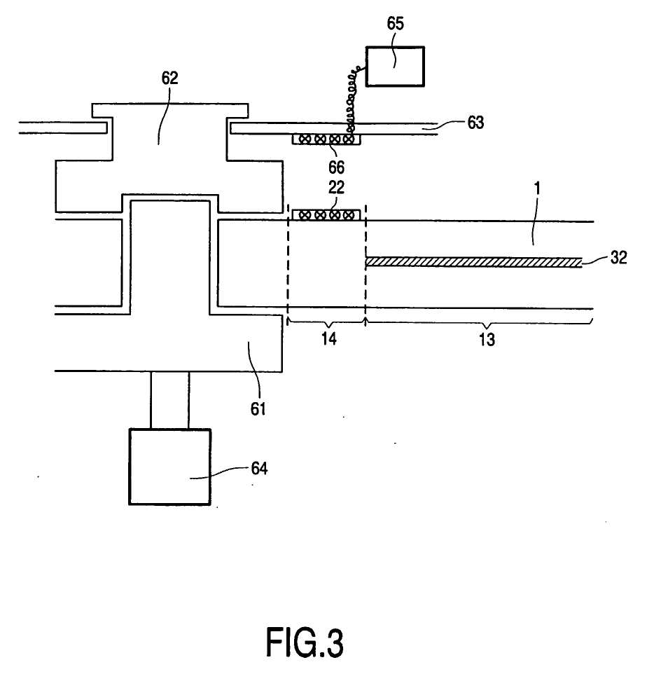

FIG. 3 is a diagrammatic elevation of a system comprising an apparatus for reading the information carrier,

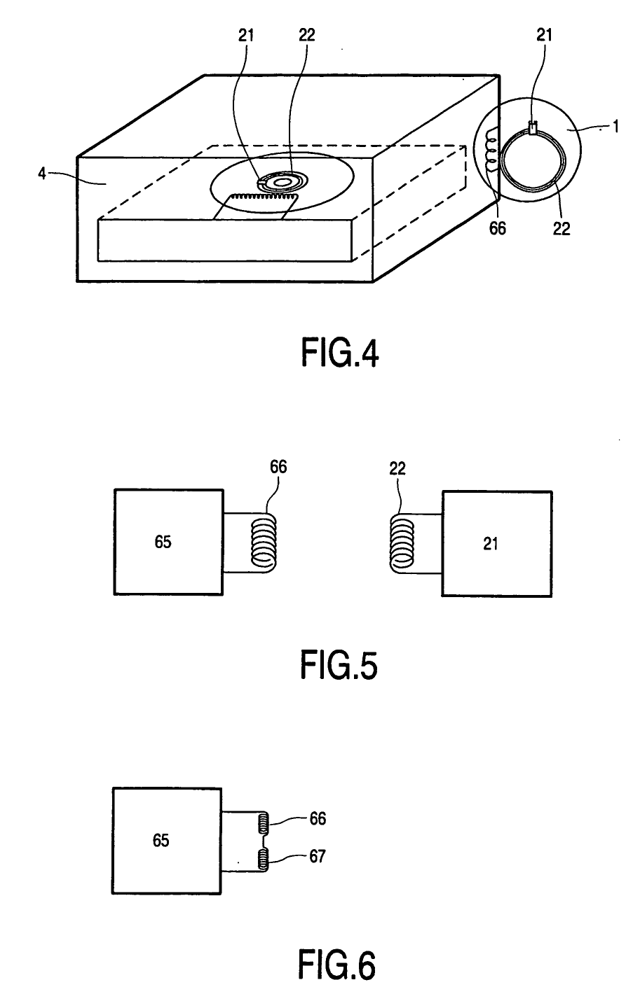

FIG. 4 is a diagrammatic elevation of an embodiment of the apparatus,

FIG. 5 is a circuit diagram of the communication means of the apparatus and the chip and antenna on the information carrier, and

FIG. 6 is a circuit diagram of an embodiment of the apparatus according to the invention.

Furthermore, the mutual dimensional ratios of the components have not been necessarily exactly depicted in the Figures for reasons of clarity, where applicable. It will be clear to those skilled in the art that alternative but equivalent embodiments of the invention are possible without departing from the essence of the invention, and that the scope of the invention is limited by the claims only. Thus the embodiments described below relate to an information carrier with an integrated circuit, such as a DVD. It will be obvious that the principles of the invention may be equally well applied to other rotating information carriers such as CD-R, CD, DVD+RW, CD-I, and other members of the family of optical information carriers. It will also be obvious to those skilled in the art that the description given below of embodiments of a playback apparatus is also applicable to a recording apparatus for writing on the optical storage unit.

FIG. 1 shows the information carrier that can be read out by the apparatus according to the invention. The information carrier in this example is a disc with an optically readable storage unit. The information carrier 1 is provided with a center hole 11 situated in the center of the disc. Several areas are defined on the information carrier 1, furthermore, which areas may each have, for example, different physical properties. The disc comprises a clamping area 12 which is used for clamping the disc between two bodies. This clamping renders it possible for the disc to move and rotate about the center of the disc in a contactless manner. This will be described in more detail below when the system is discussed. Furthermore, an information area 13 is defined on the disc, where the optically readable storage unit is present. This storage unit comprises a track which is arranged in a spiraling or concentric pattern. It is possible to read the track on the information carrier by means of a read head known to those skilled in the art. The read head comprises inter alia an optical system for focusing a light beam, for example generated by a laser diode. The optical storage unit is built up from several layers, among them a polycarbonate layer and a metal layer. A transitional region 14 is present between the clamping area 12 and the information area 13. The transitional region 14 is also constructed with the polycarbonate layer and the metal layer in the prior art. The transitional region 14 is denoted the CiD region hereinafter.

The optical information carrier 1 further comprises an integrated circuit 21 and an antenna 22 which is connected to the integrated circuit (denoted chip hereinafter) 21. An embodiment of the information carrier with the chip and the antenna shown in the CiD region can be seen in FIG. 2. The antenna is preferably a coiled antenna. The antenna is always located in the CiD region. There are no limitations as to the positioning of the chip, for example, it is possible to position the chip in the information area, but the CiD region is preferred. The chip is, for example, a MiFare RFID chip manufactured by Philips Electronics N.V. and is also described in the RFID HANDBOOK, p. 282 by Klaus Finkenzeller, published by John Wiley & Sons.

The chip provides the possibility of storing information. This information may be, for example, a decoding key for decoding the digital work stored in coded form on the information carrier. The illegal copying and distribution of the digital work on the information carrier is rendered more difficult through the provision of the decoding keys in a separate memory, and not on the information carrier itself. Another example of the use of the storage capacity in the chip is the storage of a table of contents. This table of contents may comprise all titles and performing artists of musical numbers stored on the information carrier in the case in which the digital work comprises, for example, a plurality of music albums. This information in the chip may then be read out, for example, and displayed on a screen.

The chip and the antenna are capable of achieving an electromagnetic coupling to another antenna connected to a read-out IC in a playback apparatus, as will be explained in more detail in the discussion of the system.

To promote the communication between the chip on the disc and the read-out IC, no metal layer is present in the CiD region. The metal layer is shown hatched in the plan view of an embodiment of the information carrier in FIG. 1. No eddy currents interfering with the electromagnetic coupling will arise because no metal layer is present adjacent the antenna.

FIG. 2 is a diagrammatic cross-sectional view of the first embodiment of the information carrier taken on the line II-II in FIG. 1. The optical information carrier in this embodiment is in the form of a DVD. As is known to those skilled in the art, the layered structure of this disc is such that pits and lands are formed in the polycarbonate layer 31. The binary data are encoded in these pits and lands. A reflecting metal layer 32 is laid over this polycarbonate layer. This combination of layers has a thickness of 0.6 mm. An additional polycarbonate layer 33 is provided on top of these layers for obtaining an additional strength and protection.

The antenna 22 is located in the CiD region 14 and is provided at the upper side of the disc. Although this embodiment is preferred because of the comparatively simple adaptation of the production process of optical information carriers, it is alternatively possible to provide the antenna between the layers of the disc. The antenna is then shaped in that a continuous metal layer is sputtered, from which the antenna wires are cut out by means of laser technology. The provision of the antenna on top of the disc may take place, for example, by means of a sticker. Conductive current wires are positioned in a coiled pattern on an adhesive layer and then fastened to the disc. These conductive wires form the antenna and are directly connected to the chip on the information carrier. As will be apparent to those skilled in the art, the antenna may alternatively be fastened to the lower side of the information carrier, i.e. the same side from which the optical storage unit is also read.

The metal layer 32 is present in the information area and not in the CiD region. This promotes the communication between the chip and the read-out IC. Since no metal layer is situated adjacent the antenna, no eddy currents will arise which interfere with the electromagnetic coupling.

As those skilled in the art will understand, the same principle may be applied to other optical information carrier families such as the CD family and the DVR family, in which the metal layer is at different levels in the disc.

FIG. 3 is a diagrammatic cross-sectional view of an embodiment of a system comprising the information carrier and an apparatus. The apparatus comprises inter alia reading means (not shown), for example a read head for reading out information from the optical storage unit. The apparatus further comprises a carrier body 61 on which the information carrier 1 can be laid. A pressure body 62 is subsequently fastened on the information carrier 1 so as to clamp the information carrier. The carrier body has a shaft that is passed through the center hole of the information carrier 1. The pressure body is fastened to the shaft of the carrier body. In this configuration, therefore, the information carrier is between the carrier body 61 and the pressure body 62. The information carrier makes contact with the carrier body and the pressure body in the clamping area of the information carrier. The pressure body is positioned in a bridge 63 in which it can move freely in the direction of the carrier body and can rotate about the axis of the carrier body. Furthermore, the apparatus comprises an electric motor 64 which is fastened to the carrier body and is arranged such that the information carrier 1 rotates in the apparatus, as is known to those skilled in the art.

The apparatus further comprises communication means for establishing an electromagnetic coupling with an information carrier 1 provided with an antenna and a chip as described above and shown in FIG. 1. The communication means of the apparatus comprise a read-out IC 65 and another antenna 66. The read-out IC is, for example, a MiFare RFID ReaderIC manufactured by Philips Electronics N.V. and is also described in the cited RFID HANDBOOK by Klaus Finkenzeller. This ReaderIC operates at 13.56 MHz, which corresponds to a wavelength of the electromagnetic waves of approximately 22 m. Since the distance between the two antennas is many times smaller than 22 m, all may be regarded as magnetic flux. The antenna 66 of the communication means in the apparatus is connected to the ReaderIC and has a coil-type or concentric character.

The antenna 66 of the communication means of the apparatus is preferably arranged perpendicularly above the antenna on the information carrier so as to obtain an optimum coupling. This coupling must be achieved inter alia when the information carrier is in the apparatus and the optical storage unit of the information carrier is being read out. The antenna in the apparatus may be fastened, for example, to the bridge 63 perpendicularly above the antenna on the information carrier as shown in FIG. 6. It will be clear to those skilled in the art that alternative embodiments are also possible.

FIG. 4 diagrammatically shows how the playback apparatus 4 is equipped with two antennas 66 connected to at least one read-out IC 65. The second antenna 66 is located such that it is possible to read out the chip on the information carrier through electromagnetic coupling when the information carrier is outside the apparatus. The second antenna is provided, for example, at the upper side of the apparatus or at the lateral side thereof, as shown. It is sufficient then to hold the information carrier in the vicinity of the antenna for reading of, for example, the table of contents stored in the chip. In an embodiment of the invention, the second antenna has two turns of 70 mm diameter. The antenna on the information carrier has a diameter of approximately 40 mm when it is placed in the region between the clamping area and the information area. The larger diameter of the second antenna providing for communication between the apparatus and the chip on the information carrier outside the apparatus creates a larger area in which it is possible to read out the chip. If the MiFare chip mentioned above is used, it is possible to realize an electromagnetic coupling over a distance of a few centimeters between the antenna in the apparatus and the antenna on the chip, and thus to communicate.

The placement of the second antenna is not bound to a fixed location. It is possible to place the antenna in any position adjacent the periphery of the apparatus. In an embodiment of the invention, there is no metal between the second antenna and the periphery of the antenna. This has the advantage that the communication between the antennas is promoted in that no eddy currents arise because of the absence of the metal layer.

FIG. 5 is a circuit diagram of the communication means of the apparatus and the chip and antenna on the information carrier. As is known to those skilled in the art, a current changing in time through a first coil will generate a magnetic flux which also changes in time. The inductance law states that a voltage will be induced in the first coil, but also in a second coil if the latter comprises a portion of the generated magnetic flux.

The changing magnetic flux in the antenna 66 connected to the read-out IC 65 induces a voltage in the antenna 22 connected to the chip 21 on the information carrier 1 owing to the mutual induction. Communication can thus take place between the chip on the information carrier and the read-out IC in the apparatus by means of electromagnetic coupling.

An embodiment of the apparatus according to the invention is shown in FIG. 6. The communication means of the apparatus are now constructed such that they comprise two antennas, one for communication when the information carrier is present inside the apparatus, and one for communication when the information carrier is adjacent the apparatus. These two antennas are coupled to one read-out IC. This embodiment has the advantage that the cost of an extra read-out IC is saved.

1. An apparatus for reading out an information carrier, which information carrier is provided with an integrated circuit and an antenna connected to the integrated circuit, said apparatus being provided with communication means for achieving an electromagnetic coupling with the antenna on the information carrier, characterized in that the communication means are constructed for achieving communication between the integrated circuit and the apparatus when the information carrier is present inside the apparatus and for achieving communication between the integrated circuit and the apparatus when the information carrier is present in the vicinity of the apparatus.

2. An apparatus as claimed in claim 1, characterized in that the communication means comprise at least two antennas, one for communication when the information carrier is inside the apparatus and one for communication when the information carrier is present in the vicinity of the apparatus.

3. An apparatus as claimed in claim 2, characterized in that at least two antennas are coupled to one read-out IC.

4. An apparatus as claimed in claim 3, characterized in that the two antennas are connected in series and coupled to the read-out IC.

5. An apparatus as claimed in claim 2, characterized in that the housing of the apparatus is at least partly free from metal at the area of the antenna for communication between the chip and the apparatus when the information carrier is in the vicinity of the apparatus.
